(19) United States
(12) Patent Application Publication
(10) Pub. No.: US 2025/0273067 A1
(43) Pub. Date: Aug. 28, 2025

(54) SYSTEM AND METHOD FOR COOPERATIVE UNSAFE MANEUVER RESPONSE

(71) Applicant: TOYOTA MOTOR ENGINEERING & MANUFACTURING NORTH AMERICA, INC., PLANO, TX (US)

(72) Inventors: SEYHAN UCAR, Mountain View, CA (US); EMRAH AKIN SISBOT, Mountain View, CA (US); ONUR ALTINTAS, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/589,335

(22) Filed: Feb. 27, 2024

(51) Int. Cl. G08G 1/01; B60W 60/00

(52) U.S. Cl. CPC G08G 1/0145; B60W 60/0015; G08G 1/0112; G08G 1/0125; G08G 1/0141; B60W 2556/65

(57) ABSTRACT

System and methods are directed to cooperative unsafe maneuver responses that enable vehicles to collaboratively react to a nearby vehicle that is making an unsafe maneuver to reduce the collision risks and improve overall driver safety. A cooperative unsafe maneuver response system detects an unsafe maneuver of a vehicle within the vicinity, form a vehicular micro cloud of a plurality of nearby connected vehicles, and then generate one or more cooperative guidance actions that can be collaboratively executed by multiple vehicles in the micro cloud. For example, a system can include a processor device that generates a cooperative guidance action for the vehicle in response to a detected unsafe vehicle maneuver present in the driving environment. The cooperative guidance action can be communicated to connected vehicles in the vicinity, and a controller device can execute autonomous actions to maneuver the vehicle based on the selected cooperative guidance action.

### TECHNICAL FIELD

The present disclosure generally relates to vehicle communication and vehicle navigation and/or computer-controlled driving technology. In particular, data from a plurality of vehicles having communication capabilities can be used to support computer-controlled vehicle capabilities, such as collision avoidance and unsafe driver detection.

### DESCRIPTION OF RELATED ART

Vehicle accidents (e.g., collisions) are a constant threat to drivers, passengers, pedestrians, and property. Accidents, which unfortunately result in injury, in some instances, may be caused by the driver. Unsafe driving is behavior exhibited by the driver of a vehicle that involves maneuvering the vehicle in a manner that is extremely unsafe for the current conditions of the vehicle, road, or surroundings which abuses and/or jeopardizes the safety of others. For instance, “driver caused” accidents may be attributed to different types of unsafe driving behavior, including: aggressive driving (e.g., tailgating, cut-in lane, etc.); distracted driving (e.g., swerving, delayed reaction, etc.); and reckless driving (e.g., running red lights, no-signal lane changes, etc.).

Unsafe drivers are a problem that is pervasive on roadways and can lead to severe human injury and/or property damage. According to the National Highway Traffic Safety Administrations (NHTSA), there were over 7.2 million reported car accidents in 2016—many of which were avoidable. The NHTSA has also compiled data which suggests that: 55% of all accidents include at least one aggressive driver; 87% of U.S. drivers have engaged in distracted driving; and rear-end collisions are the most frequent type of collision in the United States (and most of them due to distracted/reckless driving behavior of follower vehicles). Consequently, as a preventative measure, some vehicles currently on the market are equipped with systems and capabilities to enable hazardous conditions to be automatically recognized, such as detecting when vehicles in the surrounding vicinity are being driven unsafely (e.g., unsafe driver behavior).

### BRIEF SUMMARY OF THE DISCLOSURE

In accordance with embodiments of the disclosed technology, a system may comprise a processor device that analyzes data associated with a driving environment of a vehicle. The processor device can generate a cooperative guidance action for the vehicle in response to a detected unsafe vehicle maneuver present in the driving environment based on analyzing the data. The cooperative guidance action is communicated to one or more communicatively connected vehicles in the vicinity of the driving environment. The system can also include a controller device executing autonomous actions to maneuver the vehicle based on the selected cooperative guidance action.

In accordance with embodiments of the disclosed technology, a non-transitory computer readable medium comprising instructions, that when read by a processor, cause the processor to perform: analyzing data associated with a driving environment of a vehicle; and generating a cooperative guidance action for the vehicle in response to a detected unsafe vehicle maneuver present in the driving environment based on analyzing the data, wherein the cooperative guidance action is communicated to one or more communicatively connected vehicles in the vicinity of the driving environment. The non-transitory computer readable medium can comprise further instructions, that when read by a processor, cause the processor to perform executing autonomous actions to maneuver the vehicle based on the selected cooperative guidance action.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A-FIG. 1B is an example road environment including a vehicle implementing a cooperative unsafe maneuver response system, in accordance with an embodiment of the technology disclosed herein.

FIG. 2A-FIG. 2B is another example road environment including a vehicle implementing a cooperative unsafe maneuver response system, in accordance with an embodiment of the technology disclosed herein.

FIG. 3 is a flow diagram of an example method implementing cooperative unsafe maneuver response, in accordance with an embodiment of the technology disclosed herein.

FIG. 4 depicts an example network architecture of an in-vehicle cooperative unsafe maneuver response system, in accordance with an embodiment of the technology disclosed herein.

FIG. 5 is a schematic representation of an example vehicle with which embodiments of the cooperative unsafe maneuver response system disclosed herein may be implemented.

FIG. 6 is an example computing component that may be used to implement various features of embodiments described in the present disclosure.

The figures are not exhaustive and do not limit the present disclosure to the precise form disclosed.

### DETAILED DESCRIPTION

Some vehicles include computer-controlled operational modes, such as vehicles having adaptive cruise control mode and automated vehicles, in which a computing system is used to navigate and/or maneuver the vehicle along a travel route. During adaptive cruise control operation, for example, the driving speed of the vehicle can be limited by various factors, such as traffic congestion (e.g., preceding vehicles travelling at slower speeds, preceding vehicles stopped). In another example, many existing vehicle navigation systems alert a driver of the presence of traffic along an intended route, in order to provide traffic related information that may be pertinent to driving, such as alternate routes, time delay estimations, or automated driving actions.

Furthermore, vehicles can include advancements and innovations in safety that help prevent crashes, collisions, and other dangerous conditions in order to protect drivers and passengers. For example, some vehicles are equipped with technology, such as computer-controlled vehicle safety systems and collision avoidance systems, that are designed to support driver awareness, decision making and vehicle operation over a wide range of speeds. Unsafe driving detection can be a feature implemented by the aforementioned computer-controlled vehicle safety systems and collision avoidance systems of some vehicles currently on the market.

Unsafe driving detection systems and capabilities refer to computer-controlled vehicle technology that is designed to identify and alert drivers about nearby vehicles that may compromise road safety. These systems often use vehicle sensors and algorithms to detect suspicious or potentially dangerous driving actions of proximately located vehicles. Computer-controlled vehicle safety systems, including unsafe driving detection, can be crucial in solving such vehicle traffic related problems, and can allow for drivers and/or vehicles to make the right adjustments to make congestion easy to manage and reduce collisions, injuries, and other potential hazards. For example, an unsafe driving detection system can be designed to automatically perform real-time detection of any unsafe driver behavior, such as speeding, abrupt lane changes, or erratic driving patterns, that is being exhibited by a subject vehicle traveling in an adjacent lane on a highway, in a manner that assists the vehicle (or manual driver) to maneuver away from any detected unsafe drivers and potentially avoid collisions.

There exist locations where vehicles should follow certain well understood driving rules, such as: unsignalized intersections, where an approach to the intersection is controlled by a stop/yield sign; and signalized intersections, where the intersection is controlled by a traffic light. On occasion, in certain complicated driving environments that may be confusing to the driver, a driver may not know how to behave or may behave in a manner where they perform an unsafe driving maneuver that is risky and increases the potential of a dangerous accident (or collision). A driver's behavior can refer generally to actions, reactions, or operations, that may be performed or undertaken by a driver while operating a vehicle. At certain times while operating a vehicle, traffic conditions, environmental conditions, or the vehicle's condition and/or operating state may cause or result in a driver not knowing or understanding what action, reaction, or driving decision, should be performed upon encountering such a condition. For example, when a driver enters into a roundabout, turning into an area with reduced visibility, or when a driver is attempting to merge into a lane with a platoon of vehicles (i.e., a series of vehicles traveling at roughly the same speed in the same lane at roughly the same intervals), the driver may not know the right-of-way rules associated with the roadway or the traffic pattern. Another such example is when a driver misses their intended exit, and as a result may be confused as to whether they should refrain from performing any risky driving maneuvers (e.g., keep going and eventually loop back around) which then causes them to have to reroute. However, in this scenario, some drivers decide to engage in risky behavior in attempt to reach the correct exit, such as perform abrupt lane changes, speed to pass slower vehicles, or slamming on the brakes on the shoulder of the road, hoping they can still make the turn. In these abovementioned scenarios, drivers are often unaware of their unsafe maneuvering or driving behavior, which can still inadvertently cause a collision or pose danger to other drivers/vehicles.

Even when evasive actions can be taken (e.g., backing up vehicle to allow for more space) in order to avoid the danger presented by an unsafe driver, there may be some scenarios where the driver of an ego vehicle may not be able to react in time. In other instances, there may be nearby vehicles that impede, or otherwise block, an evasive action that can be taken by the ego vehicle attempting to avoid a vehicle being driven unsafely. Since drivers may be unaware of these factors, such as potential collisions with vehicles making an unsafe maneuver, or another vehicle blocking a needed safety maneuver, it may be advantageous to leverage vehicle connectivity capabilities to communicate and maneuver to prevent accidents in a cooperative manner.

In order to address the aforementioned and similar issues, the disclosed embodiments are directed to a cooperative unsafe maneuver response system and techniques. As disclosed herein, the system is configured to enable vehicles to collaboratively react to a nearby vehicle that is making an unsafe maneuver in a manner that further reduces the collision risks (e.g., unsafe vehicles in complicated driving environments) and prevents vehicular damage, bodily injury and/or fatality, and significantly improves overall driver safety. In the embodiments, the cooperative unsafe maneuver response system and method can detect an unsafe maneuver of a vehicle within the vicinity, form a vehicular micro cloud of a plurality of nearby connected vehicles, and then generate one or more cooperative guidance actions that can be collaboratively executed by multiple vehicles in the micro cloud.

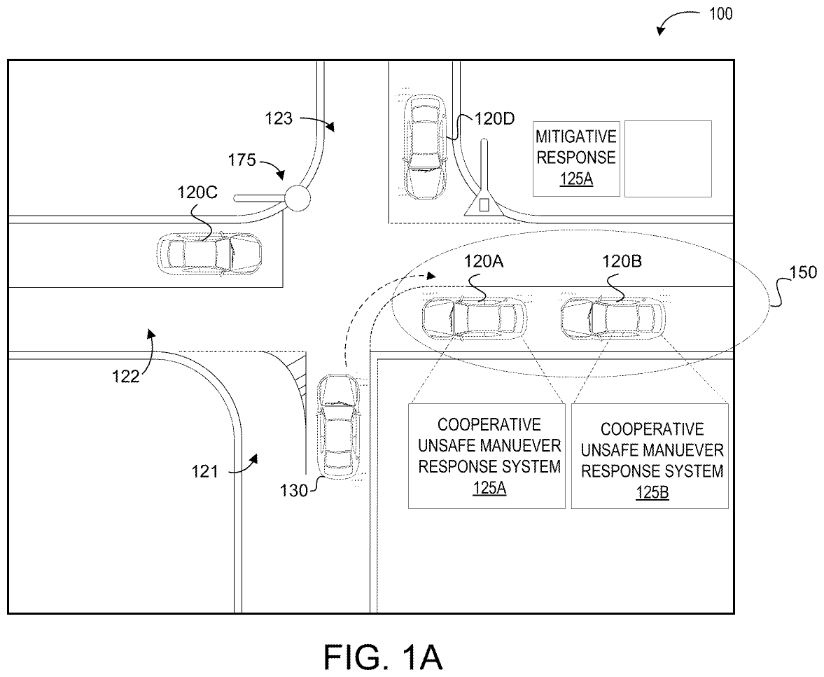

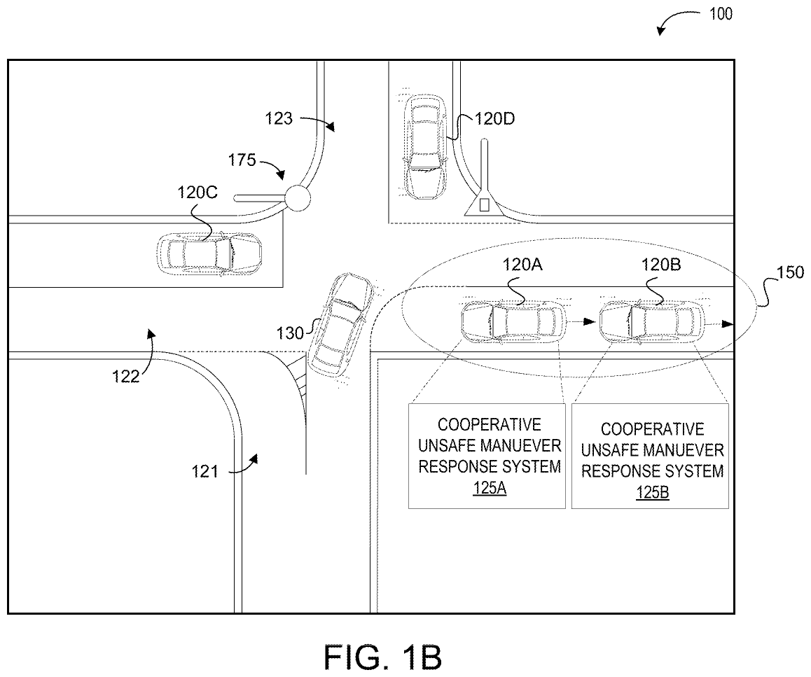

FIG. 1A-FIG. 1B are diagrams of an example environment 100 in which the cooperative unsafe maneuver response system and methods, as disclosed herein, can be implemented. The example operating environment 100 includes an ego vehicle 120A, a subject vehicle 130 and other vehicles 120B, 120C at a complicated driving environment shown as an atypical four-way intersection wherein the is no traffic signal. The atypical intersection is an any intersection that includes roadway features that may cause driver confusion, and thus may cause the driver of the subject vehicle 130 to maneuver in an unsafe manner. The roadway features can be any type of traffic signals, roadway patterns, roadway hazards etc. that may cause a driver to become confused as to how to proceed through the intersection, and consequently perform an unsafe driving maneuver. It should be understood that the operational environment 100 in FIG. 1A-FIG. 1B is described for purposes of illustration and is not intended to be limiting, thus the described cooperative unsafe maneuver response system capabilities can implement enhanced driver/vehicle safety functions that are similarly applicable to various other types of potentially risky, confusing, or dangerous driving environments that are not shown (e.g., roundabouts, exits, and the like). Thus, in another example, the atypical intersection can include an intersection with no-electricity (a traffic signal outage). The atypical four-way intersection of FIG. 1A-FIG. 1B includes a first roadway 121, a second roadway 122 and a third roadway 123. The first roadway 121 and the third roadway 123 intersect the second roadway 122 at different points, creating an offset intersection 175. The geometry of the offset intersection 175 may create some restricted/limited visibility issues for drivers at the intersection, making it more difficult for drivers to proceed through the intersection 175 safely. Particularly, FIG. 1A illustrates a scenario where a driver of the subject vehicle 130 attempts to make a right turn onto roadway 122, however the driver may have reduced visibility which causes them to cut a turn around the corner of intersection 175, where ego vehicle 120A is positioned, dangerously too close.

Additionally, the driver of subject vehicle 130 may be unaware that they are maneuvering unsafely by cutting the corner of intersection 175 and does not see that if they continue making the right turn at this angle (illustrated in FIG. 1A by dashed line) that there is an imminent danger of colliding into ego vehicle 120A. That is, vehicle 120A is positioned on the corner of roadway 122 at intersection 175, and there is a high likelihood that subject vehicle 130 will run into ego vehicle 120A along the intended path of the subject vehicle's 130 unsafe maneuver. In addition, as seen in FIG. 1A, vehicle 120B is also positioned very closely behind the ego vehicle 120A on roadway 122, which presents another risk of collision, if the ego vehicle 120A attempts to quickly perform a reverse maneuver in order to evade the oncoming subject vehicle 130.

FIG. 1A illustrates a first stage of this driving scenario within the road environment 100, where the subject vehicle 130 is initiating the unsafe “cut corner” maneuver, prior to actually entering the intersection 175. FIG. 1B illustrates a subsequent second stage of the unsafe “cut corner” maneuver scenario within the road environment 100. In FIG. 1B, the subject vehicle 130 has entered into the intersection 175 and the ego vehicle 120A and rear vehicle 120B have performed cooperative guidance actions, as described in detail below, in response to the detected unsafe maneuver of the subject vehicle 130. As seen in FIG. 1B, the ego vehicle 120A and the rear vehicle 120B coordinate to both perform reverse maneuvers, which allows the vehicles 120A, 120B to execute guidance actions that move them farther away from the corner of the intersection 175 to avoid a potential collision with the subject vehicle 130.

Particularly, vehicles 120A, 120B are shown to include the cooperative unsafe maneuver response systems 125A, 125B. The cooperative unsafe maneuver response systems 125A, 125B can be implemented as a vehicle controller, computing hardware, software, firmware, or a combination thereof, which is programmed to select actions for vehicles to mitigate traffic congestion in accordance with the disclosed techniques. The cooperative unsafe maneuver response systems 125A, 125B may be a standalone controller in some embodiments. Alternatively, cooperative unsafe maneuver response systems 125A, 125B may be implemented by configuring a main vehicle onboard processor or CPU. As previously described, vehicles 120A, 120B can obtain data from its vehicle sensors or the other communicatively connected vehicles on the road (e.g., vehicles 120C, 120D), via wireless network connectivity. This data communicated from connected vehicles can be cooperatively fused and serve as input to the cooperative unsafe maneuver response systems 125A, 125B, in some cases.

According to the embodiments, the cooperative unsafe maneuver response systems 125A, 125B have the capability to detect and/or predict when a proximate vehicle is performing an unsafe driving maneuver. In other words, the cooperative unsafe maneuver response systems 125A, 125B can implement functions of several computer-controlled operational modes, such as unsafe driver detection and collision avoidance. Referring back to the example of FIGS. 1A-1B, the cooperative unsafe maneuver response systems 125A, 125B can obtain data associated with observing the movement of subject vehicle 130 which is analyzed as input into an unsafe driver detection features of the ego vehicle 120A. The ego vehicle's 120A unsafe driver detection system features then analyze this data on the subject vehicle 130 in order to ultimately determine whether the subject vehicle 130 has characteristics where it is deemed, or otherwise identified/detected, as an unsafe driver or executing an unsafe maneuver.

Thus, ego vehicle 120A can employ its cooperative unsafe maneuver response system 125A to actively detect that the subject vehicle 130 making the dangerously close right turn into the intersection 175 is an unsafe maneuver. Further, the cooperative unsafe maneuver response system 125A can predict in real-time, based on the maneuvering path (e.g., position, direction, angular velocity, etc.) of subject vehicle 130, that ego vehicle 120A is currently positioned for an oncoming collision if an evasive action is not taken by the ego vehicle 120A quickly while the subject vehicle 130 approaches. In some embodiments, the subject vehicle 130 itself can detect/predict that an unsafe maneuver is being executed by its driver. In some embodiments, a computer system that is external to the vehicles, such as a remote/edge server, can implement the unsafe maneuver detect/predict capabilities using information that can be obtained from multiple vehicles and roadside infrastructure in the vicinity.

As alluded to above, the cooperative unsafe maneuver response systems 125A, 125B are configured execute functions of computer-controlled operational modes, such as unsafe maneuver detection and collision avoidance. Thus, the cooperative unsafe maneuver response systems 125A, 125B are configured to perform various collision avoidance features in addition to unsafe maneuver detection/prediction capabilities. For example, the vehicles 120A, 120B can employ their respective cooperative unsafe maneuver response systems 125A, 125B to effectuate autonomous or semi-autonomous actions in response to detecting that the subject vehicle 130 is an unsafe driver, which facilitates vehicle/driver safety in avoiding an unsafe driving and/or mitigating a potential collision. Examples of actions that the ego vehicle 120 can execute in response to detecting an unsafe driver, include, but are not limited to: emergency braking; evasive maneuvers (e.g., forward, reverse, etc.); acceleration/deceleration; lane change; communication; obstacle detection and tracking; predictive analysis; and the like.

Therefore, continuing with the example, the cooperative unsafe maneuver response system 125A can generate a guidance action for the ego vehicle 120A to perform in order to avoid a collision, in response to detecting that the subject vehicle 130 is maneuvering unsafely through intersection 175. Different guidance actions are implemented by the collision avoidance features of the cooperative unsafe maneuver response systems 125A, 125B according to an Anomaly Severity Index (ASI) level. For instance, an ASI level 1 can indicate that an immediate guidance action should be taken to mitigate the collision risk, as a result of sensing that there is a short distance to an unsafe vehicle. In this scenario, the cooperative unsafe maneuver response system 125A can generate a guidance action for the ego vehicle 120A to immediately perform a reverse maneuver, as the subject vehicle 130 is already in close proximity at its current position in the intersection 175. By performing an immediate guidance action, the ego vehicle 120A can move farther back from the corner (e.g., creating a greater distance away from the subject vehicle 130) and out of the angular path of oncoming subject vehicle 130 during its dangerously tight right turn through intersection 175, thereby avoiding the potential collision. In an embodiment, the ego vehicle 120A can detect the subject vehicle 130 is unsafely approaching and becomes the leader of a micro cloud 150. The ego vehicle 120A can form the micro cloud 150 and then determine the necessary guidance action.

FIG. 1A also depicts that there is another vehicle 120B in the example operating environment 100 that is positioned closely behind the ego vehicle 120A in roadway 122, waiting to be able to proceed through the intersection 175. Due to the rear vehicle 120B being stopped only a short distance to the rear of ego vehicle 120A, there is not enough space to allow for the ego vehicle 120A to safely perform the immediate guidance action generated by the cooperative unsafe maneuver response system 125A and move back out of the way of the oncoming subject vehicle 130 to avoid collision. Conventional collision avoidance systems may fail to prevent an accident from occurring in this scenario, as the ego 120A vehicle would be blocked in by the rear vehicle 120B and would not be able to safely reverse as a mitigative action. The cooperative unsafe maneuver response systems 125A, 125B, as disclosed herein, have the distinct capability to communicate and determine cooperative guidance actions that can collaboratively be taken by both vehicles 120A, 120B in a concerted effort to avoid the unsafe maneuver of the subject vehicle 130 at the intersection 175 in a manner that provides enhanced vehicle/driver safety features and improves the overall safety of all vehicles in the road environment 100.

Referring back to the operational example of FIG. 1A, the cooperative unsafe maneuver response system 125A of vehicle 120A can detect the presence of vehicle 120B that is stopped directly behind the ego vehicle 120A, which necessitates a collaboration with vehicle 120B in order for the ego vehicle 120A to be able to perform its required guidance action and immediately move in reverse. Thereafter, the cooperative unsafe maneuver response system 125A determines a vehicular micro cloud formation strategy that can be used for connectivity to other vehicles. As referred to herein, a vehicular micro cloud refers to a localized computing infrastructure that operates within a vehicular network, which enables vehicles to communicate, share data with each other, and collaborate on tasks. According to the embodiments, the cooperative unsafe maneuver response systems 125A, 125B are configured to select from different types of vehicular micro cloud formation strategies based on certain parameters relating to the driving environment/scenario in which the micro cloud is to be used. Examples of vehicular micro cloud formation strategies that can be selected by the cooperative unsafe maneuver response system 125A include but are not limited to: a stationary vehicular micro cloud; a mobile vehicular micro cloud; a chain of interdependent vehicular micro clouds; and a remote vehicular micro cloud. Details regarding vehicular micro cloud formation are described in related applications including: U.S. Pat. No. 10,587,998 titled “Managed Selection of a Geographical Location for a Micro-Vehicular Cloud” filed Dec. 18, 2017; U.S. Pat. No. 11,395,118 titled “Vehicular Micro Cloud Hubs” filed Jan. 6, 2022; and U.S. patent application Ser. No. 17/945,495 titled “Systems and Methods to Form Remote Vehicular Micro Clouds” filed Sep. 15, 2022, incorporated herein by reference in their entirety.

In this example, the cooperative unsafe maneuver response system 125A can select to form a stationary micro cloud 150 that supports communicative connectivity with the rear vehicle 120B. The cooperative unsafe maneuver response system 125A can analyze several characteristics surrounding the driving environment 100 in order to determine that the stationary micro cloud is suitable, such as the intersection 175 being a set location, and the collision risk area covering a substantively short distance (e.g., less than approximately 300 meters) and that the collision risk scenario involves few vehicles (e.g., less than 4 vehicles). FIG. 1A shows that vehicles 120A, 120B are members of the stationary vehicular micro cloud 150 which allows them to share data and react collaboratively to respond to the unsafe maneuvering of subject vehicle 130 in the intersection 175.

In an embodiment, the cooperative unsafe maneuver response system 125A can be configured with a predetermined and/or predefined relationship between various parameters related to the driving environment and a corresponding vehicle micro cloud formation strategy that is ultimately employed. In some embodiments, the cooperative unsafe maneuver response system 125A can be configured to implement various rules, tables, data structures, logic trees, algorithms, etc. that provide defined relationships for selecting a particular vehicular micro cloud formation strategy based on several parameters. For instance, parameters may be pertinent to vehicle movement and/or observed characteristics of the driving environment in order to implement the defined relationships to one or more vehicular micro cloud formation strategies. Examples of parameters that can be used for a defined correspondence to a vehicular micro cloud formation strategy includes, but are not limited to: number of vehicles, distance among vehicles; characteristics of unsafe maneuver (e.g., number of lanes expanded); the type of guidance action generated (e.g., move backwards or forward, lane changes); and the like.

In another embodiment, the cooperative unsafe maneuver response systems 125A, 125B are configured to implement Artificial Intelligence (AI)/Machine Learning (ML) techniques in order to select the appropriate vehicular micro cloud formation strategy. For example, the cooperative unsafe maneuver response systems 125A, 125B implement ML models that are trained to learn which vehicular micro clouds are optimal over time, by observing previous driving scenarios where particular characteristics and parameters were detected, and then observing how the vehicular micro cloud that was formed in that environment performed. As a result, the ML can infer a relationship to predict the most optimal vehicular micro cloud formation strategy based on driving characteristics and related parameters observed in a current driving environment.

FIG. 1B illustrates the second stage in the operational environment 100 where the ego vehicle 120A and the rear vehicle 120B react collaboratively to respond to the unsafe maneuver of the subject vehicle 130 and determined execute the cooperative guidance actions. As an example, the ego vehicle 120A can determine that the rear vehicle 120B is in the vicinity as has a communication capability, and thus can become a member of the stationary vehicular micro cloud 150 to receive communication messages. The disclosed cooperative unsafe maneuver response techniques do not require all vehicles in an area to be communicatively connected or otherwise have wireless networking capabilities, and thus can be employed in mixed traffic environments which are more prevalent in real world applications.

As the ego vehicle 120A intends to perform the initial guidance action, specifically executing a reverse maneuver in order move away from the corner of the intersection 175 to avoid the potential collision ahead (e.g., oncoming subject vehicle 130 in the intersection 175), the vehicle 120A can send a request message (also referred to herein as a maneuver message) to vehicle 120B, which is directly to the rear and has a wireless connection with vehicle 120A via the vehicular micro cloud 150. As alluded to above, because vehicle 120B is stopped so closely behind the ego vehicle 120A, there is not enough space for the ego vehicle 120A to safely perform its initial guidance action, and immediately backing up, without the rear vehicle 120B also making any adjustment maneuvers. Vehicle 120A can communicate with vehicle 120B, also being equipped with a cooperative unsafe maneuver response system 125B, prior to performing any maneuver. Thus, the cooperative unsafe maneuver response systems 125A, 125B can collaboratively apply their distinct processing functions to select one or more cooperative guidance actions that both of the vehicles 120A, 120B can coordinate and execute in concert to better avoid the potential collision with subject vehicle 130. That is, the cooperative unsafe maneuver response systems 125A, 125B execute processing which considers different data and factors related to the driving environment, and selects cooperative guidance actions, where cooperative guidance actions are control actions that are taken by one or more vehicles to execute a coordinated maneuvering of these vehicles to mitigate a potential collision, in response to a detected unsafe maneuver.

For example, the cooperative unsafe maneuver response systems 125A, 125B can obtain and analyze data related to the observed movement of the subject vehicle 130 (e.g., position, distance, speed, etc.) and data indicative of the current driving environment 100 (e.g., intersection geometry, distance between vehicles, presence of other vehicles, number of lanes, etc.) to determine one or more cooperative guidance actions, which is a coordinated immediate reverse. FIG. 1B illustrates that the determined cooperative guidance actions involve the rear vehicle 120B immediately executing a first reverse maneuver (indicated in FIG. 1B as arrow) and coordinating this action with a subsequent action that is to be performed by the ego vehicle 120A. After the rear vehicle 120B performs the first reverse maneuver, it has moved back from the ego vehicle 120A in a manner that creates enough distance for the second reverse maneuver to be performed by the ego vehicle (indicated in FIG. 1B as arrow). As space is freed up behind the ego vehicle 120A (by the rear vehicle 120B performing its portion of the cooperative guidance actions), the ego vehicle 120A can execute the second reverse maneuver. Importantly, the ego vehicle 120A has enough time to perform its portion of the selected cooperative guidance action, backing away from the corner before the subject vehicle 130 completes the dangerous right turn through the intersection 175, which would have resulted in a collision with the ego vehicle 120A in its initial position (shown in FIG. 1A). In some embodiments, the ego vehicle 120A and rear vehicle 120B perform one or more autonomous actions in order to execute their respective cooperative guidance actions (e.g., autonomous reverse maneuvers), which were collaboratively selected by the cooperative unsafe maneuver response systems 125A, 125B and provide enhanced driver/vehicle safety features.

In some embodiments, the vehicles 120A, 120B utilize one or more cooperative guidance actions that are ultimately selected by the cooperative unsafe maneuver response systems 125A, 125B as a trigger for other functions. The cooperative unsafe maneuver response systems 125A, 125B can generate notifications, warnings, alerts, and other visual, audio, and tactile outputs that enable drivers to make safer actions in operating the vehicle and provide additional reaction time for unexpected changes on the road. Furthermore, the cooperative unsafe maneuver response systems 125A, 125B can generate messages, notifications, warnings, alerts, for operators of other connected vehicles that may be traveling on the road within its vicinity, such as vehicles in the section of the road where vehicle 120A is currently traveling (e.g., within range of the wireless communication technology). For instance, these messages transmitted from vehicle 120A to other connected vehicles may notify the respective vehicle of its selected control action (e.g., reverse, lane change, deceleration), and allow for anticipation of any cooperative maneuvers to be performed by other connected vehicles. In some implementations, the messages that are communicated to other connected vehicles further also effectuate automated (or semi-automated) maneuvers of these vehicles. Referring back to the example of FIG. 1B, in the case where the cooperative unsafe maneuver response systems 125A, 125B select coordinated reverse maneuvers as the cooperative guidance actions to avoid a collision, vehicle 120A may generate messages which are communicated back to vehicle 120B notifying it of the cooperative guidance actions (e.g., reverse maneuvering of vehicle 120A), and notifying vehicle 120B of its corresponding control action, such as triggering an automated reverse maneuver for vehicle 120B. In another example, the cooperative unsafe maneuver response systems 125A, 125B may generate notifications that inform other connected vehicles about any unsafe maneuvers/drivers, detected traffic congestion along the road, traffic incidents, hazards, and other changes in the traffic condition such that those drivers have additional time to revise their actions or routes accordingly.

Additionally, in response to the cooperative unsafe maneuver response systems 125A, 125B selecting the appropriate cooperative guidance action(s), the selection data can be taken as output from the systems 125A, 125B to further notify the driver and/or effectuate automated (or semi-automated) maneuvers of the respective vehicles 120A, 120B such that collisions, slowdowns, traffic congestion, and road closures are avoided. Referring back to example where the cooperative unsafe maneuver response systems 125A, 125B determine the appropriate cooperative guidance actions, other components and/or systems of the vehicles 120A, 120B may generate alerts for the driver (e.g., indicating traffic), and the corresponding autonomous maneuvers (e.g., decreasing speed, changing directions, lane change, etc.) to automatically perform the guidance action.

Although the example described with reference to FIG. 1A-FIG. 1B include types of autonomous vehicles, the systems and methods described herein can be implemented in other types of vehicles including semi-autonomous vehicles, vehicles with automatic controls (e.g., dynamic cruise control), or other vehicles. Also, the vehicles 120A, 120B implementing the cooperative unsafe maneuver response systems 125A, 125B described with reference to FIG. 1A-FIG. 1B are a type of hybrid electric vehicle (HEV). However, this is not intended to be limiting, and the disclosed embodiments can be implemented in other types of vehicles including gasoline- or diesel-powered vehicles, fuel-cell vehicles, electric vehicles, or other vehicles.

According to an embodiment, vehicles implementing the cooperative unsafe maneuver response systems 125A, 125B (shown as vehicles 120A, 120B) can be a semi-autonomous vehicle, such as a vehicle having assisted driving capabilities, which also implements the vehicular knowledge networking and improved knowledge cycle functions, as disclosed herein. “Semi-autonomous operational mode” means that a portion of the navigation and/or maneuvering of the vehicle 120A along a travel route is performed by one or more computing systems, and a portion of the navigation and/or maneuvering of the vehicle 120A along a travel route is performed by a human driver. One example of a semi-autonomous operational mode is when an adaptive cruise control system is activated. In such case, the speed of a vehicle 120A can be automatically adjusted to maintain a safe distance from a vehicle ahead based on data received from on-board sensors, but the vehicle 120A is otherwise operated manually by a human driver. Upon receiving a driver input to alter the speed of the vehicle (e.g., by depressing the brake pedal to reduce the speed of the vehicle), the speed of the vehicle is reduced. Thus, with vehicle 120A operating as a semi-autonomous vehicle, a response can be partially automated. In an example, the controller communicates a newly generated (or updated) control to the vehicle 120A operating as a semi-autonomous vehicle. The vehicle 120A can automatically perform some of the desired adjustments (e.g., accelerating) with no human driver interaction. Alternatively, the vehicle 120A may notify a driver that driver input is necessary or desired in response to a new (or updated) safety control.

Alternatively, or in addition to the above-described modes, vehicles implementing the disclosed cooperative unsafe maneuver response systems 125A, 125B (shown as vehicles 120A, 120B) can have one or more autonomous operational modes. As used herein, “autonomous vehicle” means a vehicle that is configured to operate in an autonomous operational mode. “Autonomous operational mode” means that one or more computing systems of the vehicle 120A are used to navigate and/or maneuver the vehicle along a travel route with a limited level of input from a human driver which varies with the operational mode. As such, vehicle 120A can have a plurality of autonomous operational modes, where each mode correspondingly responds to a controller, with a varied level of automated response. In some embodiments, the vehicle 120A can have an unmonitored autonomous operational mode. “Unmonitored autonomous operational mode” means that one or more computing systems are used to maneuver the vehicle along a travel route fully autonomously, requiring no input or supervision required from a human driver. Thus, as an unmonitored autonomous vehicle 120A, responses can be highly, or fully, automated. For example, a controller can be configured to communicate controls so as to operate the vehicle 120A autonomously and safely. After the controller communicates a control to the vehicle 120A operating as an autonomous vehicle, the vehicle 120 can automatically perform the desired adjustments (e.g., accelerating or decelerating) with no human driver interaction. Accordingly, vehicle 120A can operate any of its components autonomously, such as an engine.

In some embodiments, the vehicles 120A-120D, and 130 in the environment 100 are also sensor-rich vehicles (SRVs) that are equipped with advanced vehicles sensors, described herein as ranging sensors (e.g., cameras, LIDAR, radar, ultrasonic sensors) and, in some cases, advanced computational resources. Particularly in the example of FIG. 1A-1B, at least the vehicles 120A-120B are implemented as SRVs. Accordingly, as SRVs, vehicles 120A-120B are enabled to utilize these advances sensors to sense various conditions on the roadway, and obtain data that is pertinent to traffic detection, such as, but not limited to: vehicle identifiers; the presence of other vehicles; vehicle position; vehicle speed; vehicle movement; vehicle motion direction; road data; lane data; vehicle acceleration; other static and dynamic objects; image data; planned route data; generated HD local map; processed perception data; and the like. Another subset of the plurality of vehicles in the road environment can be legacy vehicles (LVs) that have limited sensor and/or communication capabilities in comparison to the SRVs. Alternatively, the vehicles may be legacy vehicles that have some sensors that are capable of sensing and limited communication of more basic types of vehicle data, such as vehicle identifiers, vehicle location, vehicle speed, vehicle acceleration, and the like. For instance, a vehicle can be a legacy vehicle that includes Global Positioning System (GPS) sensors, which can provide the basic location, velocity, and acceleration of the vehicle.

Additionally, FIG. 1A-FIG. 1B illustrate a stationary vehicular micro cloud 150, which establishes wireless connections between communicatively connected vehicles, shown in FIG. 1A as vehicles 120A, 120B, within the same vicinity (e.g., within wireless network range) on the roadway. Due to this wireless connectivity, data can be communicated between the connected vehicles, where the data can include information such as sensor messages, maneuver messages, basic safety messages and the like. Sensor messages can include data collected by the vehicle sensors of SRVs and LVs, and other related data that may be obtained from sensors and/or devices on-board the vehicle. In some embodiments, sensor messages are implemented as a general class of wireless messages exchanged between road users and infrastructure that contains information about the objects detected in the surrounding environment. Examples could be the Sensor Data Sharing Messages standardized by SAE or the Collective Perception Messages standardized by ETSI. Maneuver messages, in some implementations, are a general class of wireless messages exchanged between road users and infrastructure that contains the future trajectory (or possible future trajectories) of the transmitting road user. Examples of such messages could be the Maneuver Coordination Message (MCM) undergoing standardization by ETSI or the Maneuver Sharing Coordination Message (MSCM) currently being standardized by SAE. Additionally, basic safety messages can be implemented as wireless messages transmitted between vehicles, where the transmitter sends its position, speed and other static/dynamic information. Basic safety messages type of message is standardized by SAE, and we do not claim it as a novelty of the invention.

As previously described, connected vehicles acting as members of the vehicular micro cloud 150 are configured to utilize types of wireless networking technology that are suitable for vehicles, which enables a vehicle to wirelessly communicate with other vehicles, infrastructure, and communication points. In the example of FIG. 1B, vehicles 120A, 120B can be equipped with vehicle-to-vehicle (V2V) communication capabilities. Thus, vehicles 120A, 120B utilize their V2V communication ability to form the stationary vehicular micro cloud 150 (as the vehicles are within range for V2V-based wireless communication), and wirelessly exchange information, such as maneuver messages, sensor data (e.g., speed and position of surrounding vehicles), and the like. That is, in the road environment 100 of FIG. 1B, V2V enables at least a subset of the vehicles traveling within the same general section of the road (e.g., vehicles 120A, 120B) to be able to communicate with each other. Vehicle 120A can receive and analyze data that is communicated over the formed micro cloud 150, and employ other vehicle components and/or systems, such as the cooperative unsafe maneuver response system 125A to help perform automated actions that avoids unsafe drivers, collisions, crashes, eases traffic congestion, and overall improves the road environment 100.

In some embodiments, the connected vehicles, namely vehicles 120A, 120B are configured to utilize other forms of wireless networking technology, such as vehicle-to-infrastructure (V2I) and/or vehicle-to-everything (V2X) capabilities. Accordingly, vehicles 120A, 120B can employ V2I and/or V2X communication to wireless exchange additional data between the vehicles and road infrastructure. Thus, in some cases, road environment 100 may include infrastructure components such as lane markings, road signs, and traffic lights which can wirelessly provide information to the vehicle, and vice versa. Consequently, the data communicated to/from connected vehicles can include additional data obtain from these infrastructure components in V2I and/or V2X communication, allowing the cooperative unsafe maneuver response systems 125A, 125B to have vast amounts real-time, information rich, data that is related to road safety, energy savings, and traffic efficiency on the roads in order to further enhance the accuracy and the overall performance of its traffic congestion mitigation functions. In some embodiments, the vehicles 120A, 120B are further configured to employ the bidirectional communication of V2I and/or V2X to also provide the roadside units, cloud/edge servers, and traffic monitoring centers, with notifications of traffic congestion that it has detected and mitigative maneuvers (e.g., control actions) to be performed, when required and/or requested from the infrastructure.

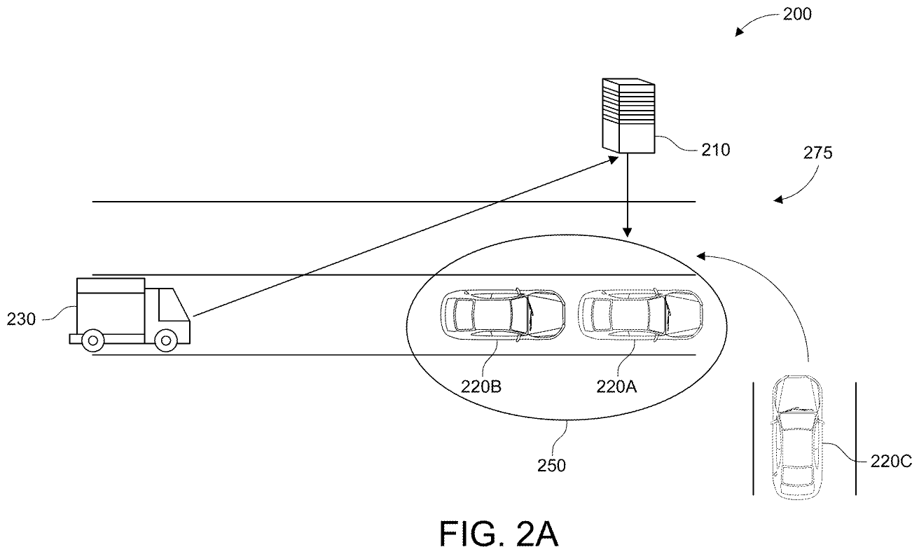

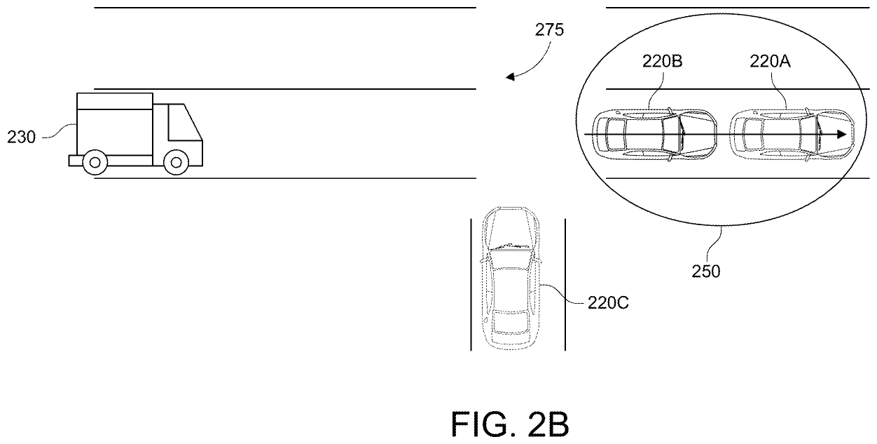

FIG. 2A-FIG. 2B depicts another example environment 200 in which the cooperative unsafe maneuver response system and methods, as disclosed herein, can be implemented. The example operating environment 200 includes an ego vehicle 220A, a subject vehicle 230, shown as a truck, and other vehicles 220B-220C at an intersection. In the example of FIG. 2A-FIG. 2B, at least the vehicles 220A, 220B are equipped with the cooperative unsafe maneuver response systems (shown in FIG. 1A) and functions, as disclosed herein. Particularly, FIG. 2A illustrates a scenario that includes a first stage of an unsafe maneuver, where the subject vehicle 230 is being driven down roadway 255 at a high rate of speed that is unsafe for the circumstances. The ego vehicle 220A is stopped at the corner of the intersection 275, in order to allow an oncoming vehicle 220C to make a left turn through the intersection 275 onto roadway 255. There is a rear vehicle 220B that is also stopped directly behind the ego vehicle 220A in the same lane of roadway 255, for instance waiting to proceed through the intersection 275. Due to the driver of the subject vehicle 230 speeding down the roadway 255, it is quickly approaching the stopped vehicles 220A, 220B at a speed that may not allow enough time and distance for the driver to react appropriately. For example, the driver of the subject vehicle 230 may be going too fast for them to be able to decelerate enough and avoid rear-ending vehicle 220B. Such a collision between the subject vehicle 230 and the rear vehicle 220B may exacerbated, causing a chain reaction where the impact to vehicle 220B causes it to collide with the ego vehicle 220A and increases the likelihood of the ego vehicle 220A crashing into the other vehicle 220C in the intersection 275. Thus, the driver of the subject vehicle 230 speeding in this manner can be considered a dangerously unsafe maneuver, that can ultimately lead to a catastrophic 4-car pileup in the example environment 200 that may further cause damage to the vehicles 220A-220C and bodily harm/injury to drivers.

FIG. 2A shows a remote server 210 that is operating within the vehicular infrastructure of the environment 200. According to the embodiments, the remote sever 210 can also be configured to implement the disclosed cooperative unsafe maneuver response system and functions, as disclosed herein. Accordingly, the remote server 210 can obtain data from the vehicles 220A, 220B, for instance, and observe the various factors related to the current driving scenario at the intersection 275. The remote server 210 can detect that the subject vehicle 230 is speeding dangerously towards the intersection 275, and subsequently determine that the subject vehicle 230 is performing an unsafe maneuver. In response to detecting the unsafe maneuver, the remote server 210 can select a guidance action that instructs the vehicle 220B to move forward. Additionally, the remote server 210 can analyze data/parameters relating to the driving environment 200 to determine which vehicular micro cloud formation strategy should be applied in order to support communication with the vehicles 220A, 220B. In the example of FIG. 2A, a remote vehicular micro cloud 250 is formed based on certain parameters, such as the collision risk area covering a distance that is greater than 300 meters. Selecting this formation strategy allows the vehicular micro cloud 250 to be formed at a remote location, namely between vehicles 220A, 220B at the intersection 275.

The remote server 210 can determine that both vehicles 220A, 220B need to move forward through the intersection 275 in order to avoid an imminent collision with the oncoming subject vehicle 250 that is speeding down the road 255. The remote server 210 implements the cooperative unsafe maneuver response capabilities to determine one or more cooperative guidance actions that are optimal for this scenario, and significantly reduces the likelihood of collision. The cooperative guidance actions shown in FIG. 2B involve coordinating a first move forward maneuver performed by the ego vehicle 220A and a second move forward maneuver performed by the rear vehicle 220B. Thus, cooperative guidance actions instruct the vehicles 220A, 220B to collaborate actions in a manner where the rear vehicle 220B follows the ego vehicle 220A forward through the intersection 275. FIG. 2B illustrates the members of the remote vehicular micro cloud 250, namely vehicles 220A, 220B, reacting collaboratively to respond to the unsafe maneuvers of the subject vehicle 230, where both vehicles 220A, 220B immediately proceed forward through the intersection 275 in order to mitigate the potential rear-end collision. In some embodiments, the cooperative guidance actions communicated to vehicles 220A, 220b can also trigger additional actions, such as vehicle 220B generating an audible notification (e.g., honk) that is loud enough to get the attention of the unsafe driver of the subject vehicle 230, as it approaches the intersection 275.

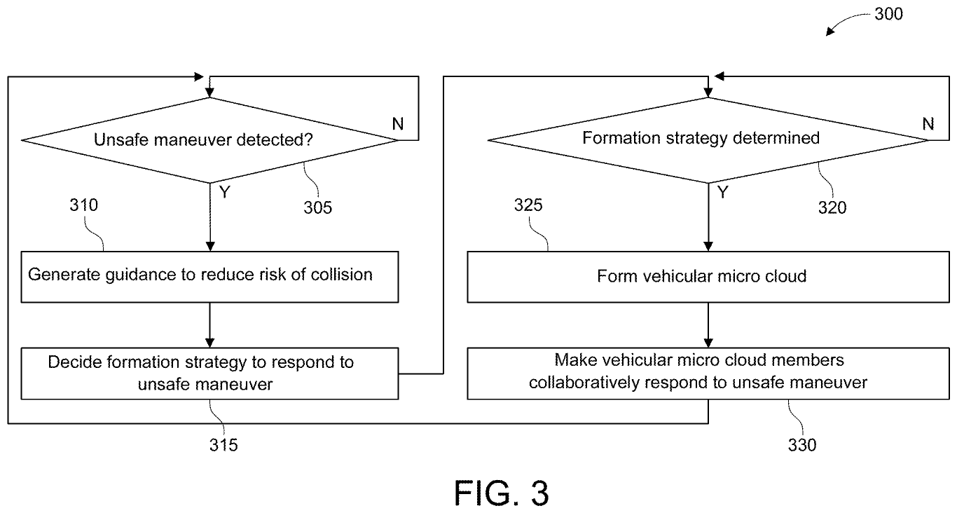

FIG. 3 is a flow diagram of an example method, depicted as process 300, that is performed according to one embodiment of the systems and methods described herein. The process 300 is a method for implementing cooperative unsafe maneuver response techniques, as disclosed. The process 300 can be a series of executable operations in a machine-readable storage media performed by a hardware processor. A computing component can be a computer device used for implementing the disclosed cooperative unsafe maneuver response described herein. For example, the computing component may be the controller of a vehicle implementing the cooperative unsafe maneuver response system described above in reference to FIGS. 1A-1B. In another implementation, the computing component executing process 300 is a computer system that is external to the vehicle, such as an edge/cloud server, which can perform the training of an AI/ML agent remotely before it is subsequently deployed to the vehicle for use.

Process 300 can begin at operation 305, where a conditional check is performed to determine whether an unsafe vehicle maneuver is detected. For example, a vehicle can employ one or more of its vehicle sensors to detect and/or monitor the movement of a proximately located subject vehicle in order to support computer-controlled operations for the vehicle, such as unsafe driver detection. In the case where an unsafe vehicle maneuver is not detected in operation 305 (shown as No in FIG. 3), then the process 300 can return to operation 305 in an iterative manner until an unsafe maneuver is observed. Alternatively, in the case where an unsafe vehicle maneuver is detected in operation 305 (shown as Yes in FIG. 3), then the process 300 can proceed to operation 310.

Next, at operation 310, guidance is generated to in order to reduce a risk of collision that is posed by the detected unsafe vehicle maneuver that is detected in previous operation 305. According to the embodiments, different guidance suggestions can be shared with vehicles according to the ASI level. For instance, an ASI level 1 can involve an immediately move forward or backward action; and an ASI level 1 can involve a speed advisory to slow down upcoming traffic.

The process 300 continues to operation 315 where a vehicular micro cloud formation strategy is determined. In some embodiments, the vehicle is equipped with the functionality to decide which vehicle micro cloud formation strategy is optimal based on the several parameters and characteristics related to the driving environment. In an alternative embodiment, a remote server performs the data processing needed to make the determination in operation 315 on behalf of the vehicle, and then communicates data/instructions to the vehicle to ultimately to execute appropriate actions based on the vehicular micro cloud formation strategy selected. Examples of types of vehicular micro cloud formation strategy that can be selected in operation 310 include but are not limited to: a stationary vehicular micro cloud; a mobile vehicular micro cloud; a chain of interdependent vehicular micro clouds; and a remote vehicular micro cloud.

Additionally, in some embodiments the relationship between observed parameters and the particular vehicular micro cloud formation strategy that is deemed most optimal is predetermined. For example, the vehicle can implement one or more predetermined rules, tables, data structures, and algorithms that are used to define a direct correspondence between parameters, which enables relationships between parameters and one or more the vehicular micro cloud formation strategy to be checked and determined in operation 315. The predetermined rules used in operation 315 can include other parameters that may be pertinent to the environment and vehicle movement in order to implement the defined relationships to one or more vehicular micro cloud formation strategy. Examples of parameters that can be used for a defined correspondence to a vehicular micro cloud formation strategy includes but are not limited to: number of vehicles; distance among vehicles; characteristics of unsafe maneuver (e.g., number of lanes expanded); type of guidance action (e.g., move backwards or forward, lane changes); and the like.

In some embodiments, an AI/ML approach is utilized to train ML model(s) to learn which vehicular micro cloud formation strategy is most optimal based on the driving characteristics of a subject vehicle that have been learned over time. Thus, the trained AI/ML model(s) can be used in operation 315 to infer which vehicular micro cloud formation strategy is optimal based on the driving environment observed in a current scenario.

Subsequently, operation 320 involves performing a conditional check to determine whether a vehicular micro cloud formation strategy has been determined by previous operation 315. In the case where a vehicular micro cloud formation strategy has not been determined (shown as No in FIG. 3), then the process 300 can return to operation 315 in an iterative manner until an appropriate vehicular micro cloud formation strategy determination is made. Alternatively, in the case where a vehicular micro cloud formation strategy is determined (shown as Yes in FIG. 3), then the process 300 can proceed to operation 325 where the vehicular micro cloud is formed between vehicles in accordance with the selected strategy.

Thereafter, operation 330 involves members of the micro cloud vehicular leveraging the network and communication capabilities to react collaboratively and respond to unsafe maneuvers in the vicinity using a cooperative guidance action. Operation 330 can involve generating one or more cooperative guidance actions, where cooperative guidance actions are control actions that are taken by one or more vehicles to execute a coordinated maneuvering of these vehicles to mitigate a collision. In some implementations, the cooperative guide actions generated in operation 330 can effectuate collaborative automated (or semi-automated) maneuvers of these vehicles. Thus, by leveraging vehicle connectivity, the disclosed method 300 can improve its accuracy and ability to mitigate collisions (in response to detecting unsafe maneuvers) by functioning cooperatively with other connected automated vehicles, and eliminates the overhead associated with computation edge and/or cloud and a fixed traffic monitoring center.

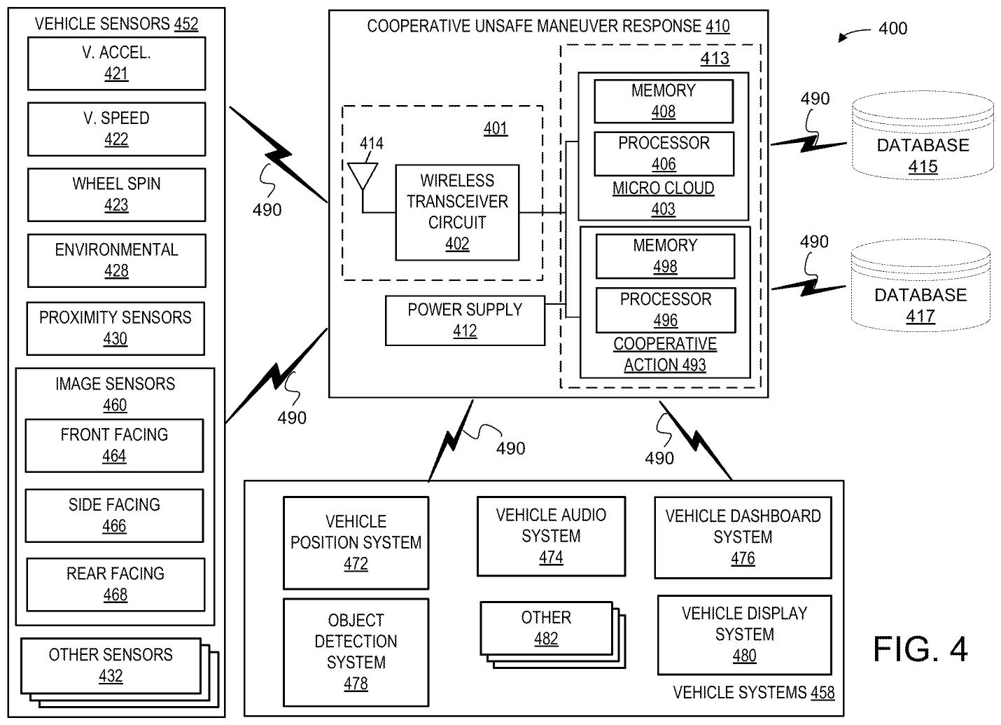

FIG. 4 illustrates an example of a cooperative unsafe maneuver response system in a vehicle 400 in accordance with one embodiment of the systems and methods described herein. The cooperative unsafe maneuver response system includes a vehicle cooperative unsafe maneuver response circuit 410 communicatively connected to a plurality of sensors 452, a plurality of vehicle systems 458, a database 415 comprising roadway data, and a database 417 comprising micro cloud formation strategy rules. Sensors 452 and vehicle systems 458 wirelessly communicate with the cooperative unsafe maneuver response circuit 410. Although in this example sensors 452 and vehicle systems 458 are depicted as communicating with cooperative unsafe maneuver response circuit 410, they can also communicate with each other as well as with other vehicle systems. The cooperative unsafe maneuver response circuit 410 can be implemented as an ECU or as part of an ECU. In other embodiments, the cooperative unsafe maneuver response circuit 410 can be implemented independently of the ECU.

The cooperative unsafe maneuver response circuit 410 in this example includes a communication circuit 401, a controller/CPU 413 comprising a micro cloud engine 403, and a cooperative guidance actions engine 493, and a power suppl 412. Each engine includes a respective processor 406, 496 and respective memory 408, 496. For example, the micro cloud engine 403 includes a processor 406, and a memory 408 configured for performing the techniques involved in determining a vehicular micro cloud formation strategy described herein, and the cooperative guidance actions engine 493 includes a processor 496 and a memory 498 configured for performing the techniques involve in implementing cooperative guidance actions between multiple vehicles to mitigate a collision described herein.

Processor 406 can include one or more GPUs, CPUs, microprocessors, or any other suitable processing system. Processor 406 may include a single core or multicore processors. The memory 408 may include one or more various forms of memory or data storage (e.g., flash, RAM, etc.) that may be used to store instructions and variables for processor 406 as well as any other suitable information, such as, one or more of the following elements: rules data; resource data; GPS data; and base data, as described below. Memory 408 can be made up of one or more modules of one or more different types of memory, and may be configured to store data and other information as well as operational instructions that may be used by the processors 406 and 496.

Although the example of FIG. 4 is illustrated using processor and memory circuitry, as described below with reference to circuits disclosed herein, controller/CPU 413 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up the cooperative unsafe maneuver response circuit 410. Communication circuit 401 includes either or both a wireless transceiver circuit 402 with an associated antenna 414 and a wired I/O interface with an associated hardwired data port (not illustrated). Communication circuit 401 can provide for V2X communications capabilities, allowing the cooperative unsafe maneuver response circuit 410 to communicate with edge devices, such as roadside equipment (RSE), network cloud servers and cloud-based databases, and/or other vehicles.

As this example illustrates, communications with the cooperative unsafe maneuver response circuit 410 can include either or both wired and wireless communications circuits 401. Wireless transceiver circuit 402 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 414 is coupled to wireless transceiver circuit 402 and is used by wireless transceiver circuit 402 to transmit radio signals wirelessly to wireless equipment with which it is connected and to receive radio signals as well. These RF signals can include information of almost any sort that is sent or received by the vehicle sensing mechanism selection circuit 410 to/from other entities such as sensors 452 and vehicle systems 458.

Power supply 412 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or it can include any other suitable power supply.

In the illustrated example, sensors 452 include vehicle acceleration sensors 421, vehicle speed sensors 422, wheelspin sensors 423 (e.g., one for each wheel), environmental sensors 428 (e.g., to detect salinity or other environmental conditions), proximity sensor 430 (e.g., sonar, radar, lidar or other vehicle proximity sensors), and image sensors 460. Additional sensors (i.e., other sensors 432) can be included as may be appropriate for a given implementation of the cooperative unsafe maneuver response circuit 410.

The sensors 452 include front facing image sensors 464, side facing image sensors 466, and/or rear facing image sensors 468. Image sensors may capture information which may be used in detecting not only vehicle conditions but also detecting conditions external to the ego vehicle 120 (shown in FIG. 1A) as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 460 can be used to, for example, to detect objects in an environment surrounding ego vehicle 120, for example, traffic signs indicating a current speed limit, road curvature, obstacles, surrounding vehicles, and so on. For example, one or more image sensors 460 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 460 may include cameras that may be used with and/or integrated with other proximity sensors 430 such as LIDAR sensors or any other sensors capable of capturing a distance. As used herein, a sensor set of a vehicle may refer to sensors 452 and image sensors 460 as a set.

Vehicle systems 458 include any of a number of different vehicle components or subsystems used to control or monitor various aspects of the vehicle and its performance. In this example, the vehicle systems 458 includes a vehicle positioning system 472; vehicle audio system 474 comprising one or more speakers configured to deliver audio throughout the vehicle; object detection system 478 to perform image processing such as object recognition and detection on images from image sensors 460, proximity estimation, for example, from image sensors 460 and/or proximity sensors, etc. for use in other vehicle systems; suspension system 480 such as, for example, an adjustable-height air suspension system, or an adjustable-damping suspension system; and other vehicle systems 482 (e.g., (e.g., Advanced Driver-Assistance Systems (ADAS), such as forward/rear collision detection and warning systems, pedestrian detection systems, autonomous or semi-autonomous driving systems, and the like).

The vehicle positioning system 472 includes a global positioning system (GPS). Ego vehicle 120 and the one or more connected vehicles may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a location (e.g., an area of defined space surrounding a geographic location or geographic position). The example embodiments described herein may provide positioning information that describes a geographic position of a vehicle with an accuracy of one or more of: (1) at least plus or minus 1.5 meters in relation to the actual geographic position of the vehicle in two dimensions including a latitude and a longitude; and (2) at least plus or minus 3 meters in relation to the actual geographic position of the vehicle in an elevation dimension. Accordingly, the example embodiments described herein are able to describe the geographic position of the vehicle with lane-level accuracy or better.

Network 490 may be a conventional type of network, wired or wireless, and may have numerous different configurations including a star configuration, token ring configuration, or other configurations. Furthermore, the network 490 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 490 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 490 may include one or more IEEE 802.11 wireless networks.

In one embodiment, data comprising the location of vehicle is captured by the vehicle position system 458. The vehicle position system 458 can include one or more sensors 452 configured to capture vehicle position data. The vehicle positioning system 472 communicates with the cooperative unsafe maneuver response circuit 410 to communicate and utilize actions at the ego vehicle 120 for various driving and/or maneuvering functions, including autonomous or semi-autonomous vehicle/driver safety features.

In an embodiment, the cooperative unsafe maneuver response system produces notifications for the driver of the ego vehicle 120 using one or more notification methods. For example, the driver may receive a visual and/or audible notification that the vehicle may need to perform a maneuver to avoid an approaching unsafe driver, traffic incident, and/or traffic congestion, based on data that the cooperative unsafe maneuver response circuit 410 has analyzed accordance with the capabilities, as disclosed herein. In one embodiment, the notification methods include the vehicle systems 458 comprising the vehicle audio system 472 and the vehicle dashboard system 476. The notification methods includes visual and/or audible methods of informing the driver of safety related issues. In one embodiment, the notification methods include notifying the driver of the ego vehicle 120 via one or more vehicle systems 458. For example, in one embodiment, the driver is notified of an unsafe driver via the vehicle audio system 474 (e.g., instructions played/broadcasted over one or more vehicle speakers), the vehicle display system 480 and/or the vehicle dashboard system 476. In one embodiment, the driver is notified of safety issues by a navigation system within the instrument cluster and the dashboard GUI. The notification can include visual instructions (e.g., visual directions on how to proceed), and/or auditory instructions (e.g., verbal commands from the vehicle sensing mechanism selection system to the driver).

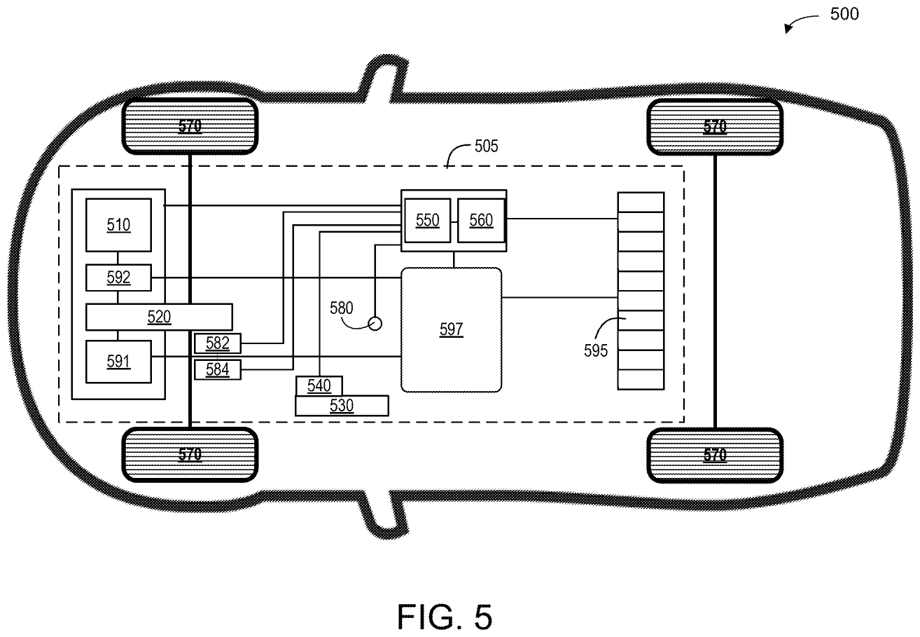

FIG. 5 illustrates an example hybrid electric vehicle (HEV) 500 in which various embodiments for the cooperative unsafe maneuver response system are implemented. For example, in one embodiment, the ego vehicle 120 (shown in FIG. 1A) is a HEV 500. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs.

Here, HEV 500 includes drive force unit 505 and wheels 570. Drive force unit 505 includes an engine 510, motor generators (MGs) 591 and 592, a battery 595, an inverter 597, a brake pedal 530, a brake pedal sensor 540, a transmission 520, a memory 560, an electronic control unit (ECU) 550, a shifter 580, a speed sensor 582, and an accelerometer 584.

Engine 510 primarily drives the wheels 570. Engine 510 can be an ICE that combusts fuel, such as gasoline, ethanol, diesel, biofuel, or other types of fuels which are suitable for combustion. The torque output by engine 1410 is received by the transmission 520. MGs 591 and 592 can also output torque to the transmission 520. Engine 510 and MGs 591 and 592 may be coupled through a planetary gear (not shown in FIG. 4). The transmission 520 delivers an applied torque to the wheels 570. The torque output by engine 510 does not directly translate into the applied torque to the wheels 570.

MGs 591 and 592 can serve as motors which output torque in a drive mode, and can serve as generators to recharge the battery 595 in a regeneration mode. The electric power delivered from or to MGs 591 and 592 passes through inverter 597 to battery 595. Brake pedal sensor 540 can detect pressure applied to brake pedal 530, which may further affect the applied torque to wheels 570. Speed sensor 582 is connected to an output shaft of transmission 520 to detect a speed input which is converted into a vehicle speed by ECU 1450. Accelerometer 584 is connected to the body of HEV 500 to detect the actual deceleration of HEV 500, which corresponds to a deceleration torque.

Transmission 520 is a transmission suitable for an HEV. For example, transmission 520 can be an electronically controlled continuously variable transmission (ECVT), which is coupled to engine 510 as well as to MGs 591 and 592. Transmission 520 can deliver torque output from a combination of engine 510 and MGs 591 and 592. The ECU 550 controls the transmission 520, utilizing data stored in memory 560 to determine the applied torque delivered to the wheels 570. For example, ECU 550 may determine that at a certain vehicle speed, engine 510 should provide a fraction of the applied torque to the wheels while MG 491 provides most of the applied torque. ECU 550 and transmission 540 can control an engine speed (NE) of engine 540 independently of the vehicle speed (V).

ECU 540 may include circuitry to control the above aspects of vehicle operation. ECU 540 may include, for example, a microcomputer that includes a one or more processing units (e.g., microprocessors), memory storage (e.g., RAM, ROM, etc.), and I/O devices. ECU 540 may execute instructions stored in memory to control one or more electrical systems or subsystems in the vehicle. ECU 540 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 541 and 542 each may be a permanent magnet type synchronous motor including for example, a rotor with a permanent magnet embedded therein. MGs 541 and 542 may each be driven by an inverter controlled by a control signal from ECU 540 so as to convert direct current (DC) power from battery 545 to alternating current (AC) power, and supply the AC power to MGs 541, 542. MG 542 may be driven by electric power generated by motor generator MG 541. It should be understood that in embodiments where MG 541 and MG 542 are DC motors, no inverter is required. The inverter, in conjunction with a converter assembly may also accept power from one or more of MGs 541, 542 (e.g., during engine charging), convert this power from AC back to DC, and use this power to charge battery 495 (hence the name, motor generator). ECU 550 may control the inverter, adjust driving current supplied to MG 592, and adjust the current received from MG 591 during regenerative coasting and braking.

Battery 595 may be implemented as one or more batteries or other power storage devices including, for example, lead-acid batteries, lithium ion, and nickel batteries, capacitive storage devices, and so on. Battery 595 may also be charged by one or more of MGs 591, 592, such as, for example, by regenerative braking or by coasting during which one or more of MGs 591, 592 operates as generator. Alternatively (or additionally, battery 595 can be charged by MG 591, for example, when HEV 1400 is in idle (not moving/not in drive). Further still, battery 595 may be charged by a battery charger (not shown) that receives energy from engine 510. The battery charger may be switched or otherwise controlled to engage/disengage it with battery 595. For example, an alternator or generator may be coupled directly or indirectly to a drive shaft of engine 510 to generate an electrical current as a result of the operation of engine 510. Still other embodiments contemplate the use of one or more additional motor generators to power the rear wheels of a vehicle (e.g., in vehicles equipped with 4-Wheel Drive), or using two rear motor generators, each powering a rear wheel.

Battery 595 may also be used to power other electrical or electronic systems in the vehicle. Battery 595 can include, for example, one or more batteries, capacitive storage units, or other storage reservoirs suitable for storing electrical energy that can be used to power MG 591 and/or MG 592. When battery 595 is implemented using one or more batteries, the batteries can include, for example, nickel metal hydride batteries, lithium ion batteries, lead acid batteries, nickel cadmium batteries, lithium ion polymer batteries, and other types of batteries.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

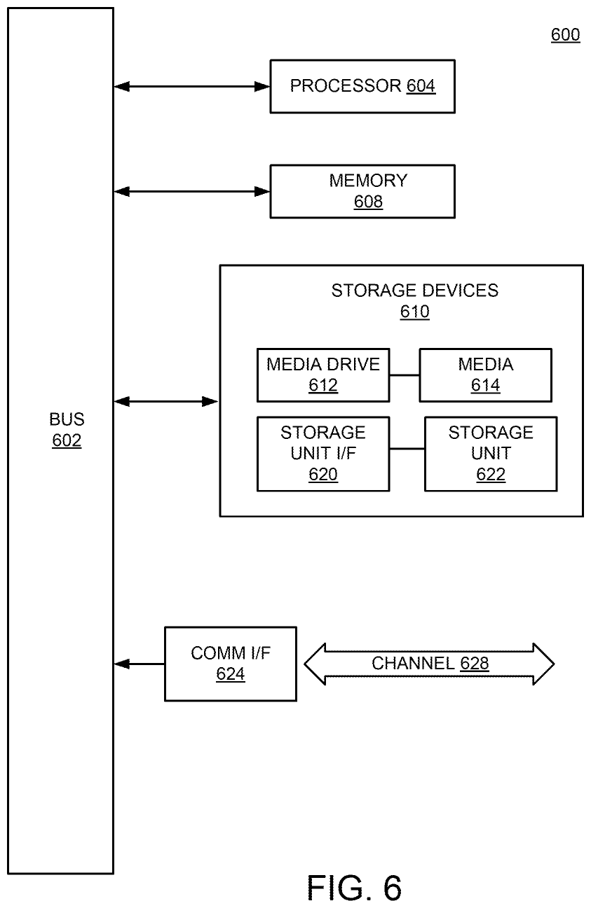

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor 604. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a processor device analyzing data associated with a driving environment of a vehicle and generating a cooperative guidance action for the vehicle in response to a detected unsafe vehicle maneuver present in the driving environment based on analyzing the data, wherein the cooperative guidance action is communicated to one or more communicatively connected vehicles in the vicinity of the driving environment; and
a controller device executing autonomous actions to maneuver the vehicle based on the selected cooperative guidance action.

2. The system of claim 1, wherein the system comprises a wireless communication device connected to one or more communicatively connected vehicles via a vehicular micro cloud.

3. The system of claim 2, wherein the processor device determines a formation strategy for the vehicular micro cloud based on the data associated with a driving environment of a vehicle.

4. The system of claim 3, wherein the formation strategy for the vehicular micro cloud comprises at least one of: a stationary vehicular micro cloud; a mobile vehicular micro cloud; a chain of interdependent vehicular micro clouds; and a remote vehicular micro cloud.

5. The system of claim 1, comprising vehicle sensors generating the data associated with the driving environment.

6. The system of claim 3, wherein the processor device generates messages for communicating the cooperative guide action to the one or more communicatively connected vehicles via the vehicular micro cloud.

7. The system of claim 6, wherein the communicated cooperative guidance action effectuates one or more autonomous actions to maneuver the one or more communicatively connected vehicles in collaboration with the vehicle.

8. The system of claim 1, wherein the processor device generates control commands to effectuate the autonomous actions to maneuver the vehicle based on the cooperative guidance action.

9. The system of claim 4, wherein the processor determines the formation strategy for the vehicular micro cloud based on one or more defined parameters associated with the driving environment.

10. The system of claim 4, wherein the processor device determines the formation strategy for the vehicular micro cloud more vehicle by applying a trained Artificial Intelligence (AI)/Machine Learning (ML) model.

11. The system of claim 1, wherein the processor device detects the unsafe vehicle maneuver present in the driving environment based on obtaining data associated with the movement of an unsafe vehicle in the vicinity.

12. A non-transitory computer readable medium comprising instructions, that when read by a processor, cause the processor to perform:
analyzing data associated with a driving environment of a vehicle;
generating a cooperative guidance action for the vehicle in response to a detected unsafe vehicle maneuver present in the driving environment based on analyzing the data, wherein the cooperative guidance action is communicated to one or more communicatively connected vehicles in the vicinity of the driving environment; and
executing autonomous actions to maneuver the vehicle based on the selected cooperative guidance action.

13. The non-transitory computer readable medium of claim 12, further comprising instructions, that when read by a processor, cause the processor to further perform determining a formation strategy for the vehicular micro cloud based on the data associated with a driving environment of a vehicle.

14. The non-transitory computer readable medium of claim 13, further comprising instructions, that when read by a processor, cause the processor to further perform generating messages for communicating the cooperative guide action to the one or more communicatively connected vehicles via the vehicular micro cloud.

15. The non-transitory computer readable medium of claim 14, wherein the communicated cooperative guidance action effectuates one or more autonomous actions to maneuver the one or more communicatively connected vehicles in collaboration with the vehicle.

16. A method, comprising:
analyzing data associated with a driving environment of a vehicle;
detecting an unsafe maneuver present in the driving environment based on analyzing the data;
generating a cooperative guidance action for the vehicle in response to a detected unsafe vehicle maneuver present in the driving environment based on analyzing the data;
forming a vehicular micro cloud comprising one or more communicatively connected vehicles, wherein the forming comprises selecting a formation strategy for the vehicular micro cloud based on data associated with a driving environment; and
communicating the cooperative guidance action to the one or more communicatively connected vehicles via the vehicular micro cloud, wherein the wherein the communicated cooperative guidance action effectuates one or more autonomous actions to maneuver the vehicle and the one or more communicatively connected vehicles in collaboration with the vehicle in response to the detected unsafe maneuver.

17. The method of claim 15, wherein the formation strategy for the vehicular micro cloud comprises at least one of: a stationary vehicular micro cloud; a mobile vehicular micro cloud; a chain of interdependent vehicular micro clouds; and a remote vehicular micro cloud.

18. The method of claim 15, wherein the processor device generates messages for communicating the cooperative guide action to the one or more communicatively connected vehicles via the vehicular micro cloud.

19. The method of claim 18, wherein determining the formation strategy for the vehicular micro cloud is based on one or more defined parameters associated with the driving environment, the one or more defined parameters associated with the driving environment comprising one or more of: number of vehicles, distance among vehicles;
characteristics of the unsafe maneuver; and a type of the cooperative guidance action.

20. The method of claim 15, wherein determining the formation strategy for the vehicular micro cloud more vehicle by applying a trained Artificial Intelligence (AI)/Machine Learning (ML) model.
